(19) United States
(12) Patent Application Publication
(10) Pub. No.: US 2010/0226793 A1
(43) Pub. Date: Sep. 9, 2010

(54) METHOD FOR DETERMINING THE FLOW RATE OR THE ACTUATION FREQUENCY OF A FLUID PUMP, PARTICULARLY IN AN ELECTRONIC MOTOR VEHICLE BRAKE SYSTEM

(76) Inventor: Erhard Beck, Weilburg (DE)

Correspondence Address: RATNERPRESTIA, P.O. BOX 980, VALLEY FORGE, PA, 19482, US

(21) Appl. No.: 12/668,931

(22) PCT Filed: May 15, 2008
(86) PCT No.: PCT/EP2008/055940

§ 371 Date: Apr. 16, 2010

(30) Foreign Application Priority Data
Jul. 14, 2007 (EP) 10 2007 032 949.2

(51) Int. Cl. F04B 49/06; G01M 19/00

(52) U.S. Cl. 417/53; 73/168

(57) ABSTRACT

A method, and use of the method in motor vehicle brake control systems, for determining the delivery capacity or the frequency of activation of a fluid pump, in particular a hydraulic pump, in an electronic pressure control unit, wherein the latter comprises not only a pressure circuit controller which is activated by analogized valve actuation but also a pump power setting means for setting the delivery capacity of the hydraulic pump, in which the frequency of movement of the mechanical pumping unit is determined by pressure fluctuations of the delivery fluid, wherein the fluctuations are acquired by reference to changes in the magnetic flux in the region of the actuation magnetic field of an electromagnetically actuated fluid valve.

### CROSS REFERENCE TO RELATED APPLICATIONS

This application is the U.S. national phase application of PCT International Application No. PCT/EP2008/055940, filed May 15, 2008, which claims priority to German Patent Application No. 10 2007 032 949.2, filed Jul. 14, 2007, the contents of such applications being incorporated by reference herein.

### BACKGROUND OF THE INVENTION

1. Field of the Invention

The invention relates to a method for determining the flow rate or the actuation frequency of a fluid pump, particularly in an electronic motor vehicle brake system.

2. Description of the Related Art

WO 2007/025951 which is incorporated by reference, describes a method for determining an admission pressure which is present between a master brake cylinder and an inlet valve of a wheel brake cylinder of a motor vehicle brake system, which method determines the admission pressure by taking into account the profile of a run-on voltage of an electric motor, operated in a clocked fashion, of a hydraulic pump. The motor pump assembly which is composed of a motor and a pump is used to feed back brake fluid from a low pressure accumulator into the master brake cylinder or to actively build up pressure without the brake being activated by the driver during brake control processes such as TCS, ACC or ESP which are known per se. In order to determine the admission pressure, electrical characteristic variables of the voltage profile are measured and are respectively used to determine an admission pressure value. The method permits the admission pressure which is present in the brake system upstream of the inlet valve to be set without costly pressure sensors.

The actuation chain performed by the motor and pump continues to be subject to tolerances, not only for reasons of fabrication technology, which make use of the above described method difficult in practice.

For this reason, the problem still arises of setting the admission pressure in an electrohydraulic pressure control device as precisely as possible. Furthermore, the electronic pressure control device is to operate particularly economically and quietly when a buildup of pressure is actively occurring.

### SUMMARY OF THE INVENTION

The invention relates to the idea of determining the delivery capacity or the frequency of activation of a fluid pump, in particular a hydraulic pump, by using what is referred to as the TPM (Tappet Position Monitoring) method. With the TPM method it is possible to use a control means to set the tappet position in an electromagnetically actuated valve or the force acting on the tappet of the valve. The position of the valve tappet can also be determined by utilizing this principle. The method is surprisingly so sensitive that it can also be used to acquire pressure pulsations of the pump. According to aspects of the invention, the delivery capacity of the pump can then be inferred from the pressure pulsations.

The electronic pressure control assembly which is used to carry out the method preferably has means for the analog actuation, which is known per se, of seat valves which are primarily designed for hydraulic switching processes. These valves are increasingly used as inlet valves or isolating valves within a wheel pressure control means. The preferred application of a brake system is to control the pressure in the wheel brake cylinders. The evaluation of the tappet movement is preferably carried out at an isolating valve.

The pumping capacity setting means is preferably composed of a PWM current controller and an electromotor which drives the pump assembly. The mechanical pumping unit of the pump assembly may be, for example, an eccentric piston pump. The number of piston strokes is in a fixed relationship with the period of the pressure fluctuations which are generated. The magnetic flux in the region of the actuation magnetic field of the fluid valve which is used to observe the fluctuations permits conclusions to be drawn about the pump fluctuations since they act on the tappet of the valve via the fluid connecting lines. The change in flux which is brought about is preferably determined by means of the induction signal of a current loop in the magnetic circuit of the fluid valve. The fluid valve is in particular hydraulically connected to the output side of the pump. The evaluation of the induction signal permits a conclusion to be drawn about the period of the pressure fluctuations since the period of the induction signal corresponds essentially to the period of the pressure fluctuations. The frequency of movement of the mechanical pumping unit (rotational speed, clock rate) is therefore determined by means of the pressure fluctuations of the delivery fluid.

According to aspects of the invention, the pumping capacity is set selectively using the determination of the delivery capacity or of the frequency of activation, or is adjusted with a controller.

The electrical induction signal of a current loop in the region of the actuation magnetic field of the electromagnetically actuated fluid valve is preferably used to form the electrical measurement signal. This current loop can in particular either be part of the actuation coil itself (for example the third tap on the actuation coil) or can be a separate auxiliary coil.

As already described above, when there is a tappet movement which is caused by a periodic or else non-periodic change in pressure at the valve (change in the differential pressure), the magnetic field, to be more precise the magnetic flux, in the region of the valve coil changes. According to one preferred embodiment, this change can be determined using a current loop in the region of the coil magnetic field or directly by means of the actuation coil. In the TPM method, the position of the valve tappet or the tappet force is preferably adjusted by the actuation electronics to a determined setpoint value using a control process. In particular an induction signal, picked up in the region of the valve coil, of the current loop is used here as an actual variable. The tappet reaction can be evaluated in a particularly sensitive way if the tappet is located at the equilibrium of forces, or in the vicinity of said equilibrium, between the magnetic force (minus or plus the spring force) and the hydraulic force. If the forces are far apart from one another, the tappet cannot react, or cannot react sufficiently sensitively, to a change in pressure. It may then be the case that the tappet only exhibits a minimum reaction to a change in pressure of the valve without the tappet position changing to an appreciable degree. However, the TPM control electronics can adjust the valve current according to one preferred embodiment to such an extent that the predefined tappet position is not changed. In this case, only the force conditions at the valve change (owing to a relatively high differential pressure, a relatively high valve current is set). In this case, the pressure pulsations can be detected only from a manipulated variable processed in the control means or from changes in actual values. According to a further preferred embodiment, the change in flux is therefore determined by means of changes in the manipulated variables or the actual variables within the TPM control means.

On the basis of the frequency of movement which is acquired according to the method described above, it is then preferably possible

a) to adjust the delivery capacity and/or the admission pressure of a fluid valve which is connected in the delivery circuit of the pump or

b) to determine the delivery capacity and/or the admission pressure of a fluid valve which is connected in the delivery circuit of the pump with a value for the delivery volume of the pump per stroke or revolution.

The invention is also related to the use of the method described above in motor vehicle brake control systems, such as an adaptive cruise controller (ACC), traction control system (TCS) or electronic stability program (ESP).

Further preferred embodiments can be found in the following description of an exemplary embodiment with reference to figures.

### BRIEF DESCRIPTION OF THE DRAWINGS

FIG. 1 is a schematic illustration of a brake device for ABS, TCS, ACC and ESP control processes, and

FIG. 2 is a schematic illustration of a control circuit for regulating the magnetic flux with a measuring coil.

### DETAILED DESCRIPTION OF THE PREFERRED EMBODIMENTS

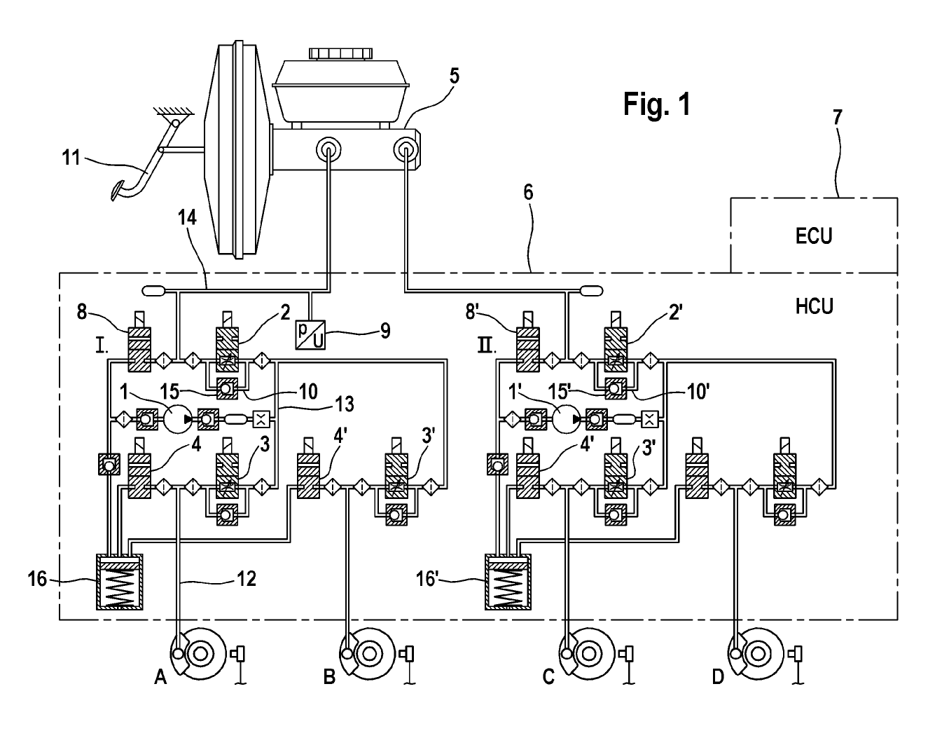

In FIG. 1, a tandem master cylinder 5 is connected to a hydraulic unit 6 (HCU) of an electronic motor vehicle brake system. The electronic unit 7 (ECU) comprises a microprocessor/controller system with which the actuators and sensors which are contained in the valve block can be controlled or measured electronically. The hydraulic unit 6 is divided into two brake circuits I and II. In addition, each of the brake circuits comprises two wheel pressure circuits (A, B and C, D, respectively) each with an inlet valve 3 or 3′, respectively, and an outlet valve 4 or 4′, respectively. The electronic system of the ECU 7 comprises a multi-channel current controller which permits independent control of the currents through the coils of the isolating valves 2, 2′ and the inlet valves 3, 3′. The reference symbols 8 and 8′ denote electronic changeover valves which are closed in the currentless state. In the hydraulic line 8 which leads to the master cylinder 5 there is an input pressure sensor 9. The brake system which is illustrated comprises no further pressure sensors in the wheel pressure circuits themselves. The motor-pump assembly 1 or 1′ serves to build up pressure actively in the ACC, TCS and ESP control systems and to feed back the pressure medium which has been discharged at the outlet valves and is located in the low pressure accumulator 16 or 16′. When the pump 1 is switched on, it feeds pressure volume in the direction of the line 13, with the result that the admission pressure is increased. Owing to the buildup of pressure by the pump, the pressure at the outlet of the pump pulsates in a pressure range which is dependent on the design of the hydraulic components.

In order to determine the pump delivery capacity, pump 1 is firstly actuated with a predefined PWM current in order to generate pressure pulsations. The isolating valve 2 is operated in the TPM control mode. In this mode, the valve tappet is held in a suitable intermediate position by the electronic control arrangement which is described further below. Owing to the pressure pulsations, periodic changes in differential pressure at the isolating valve 2 which are due to slight changes in position of the tappet, can then be measured by the electronic system.

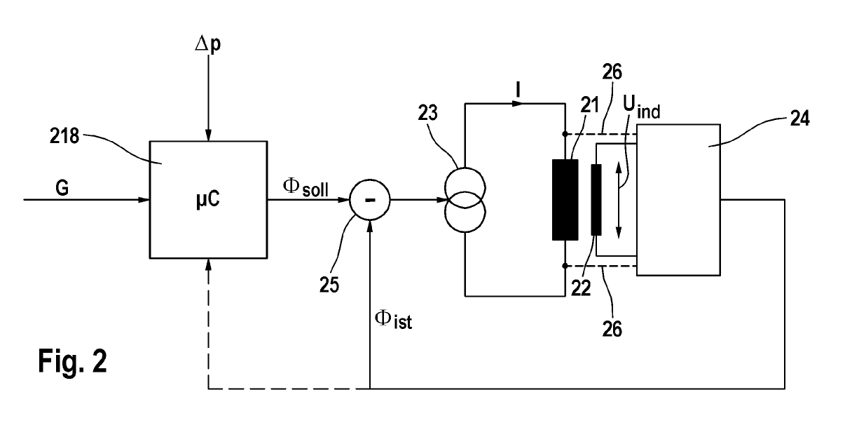

The microcontroller system 218 in FIG. 2 carries out all the control functions of the brake device and is arranged inside the ECU 7. Said ECU 7 actuates the coil of the electromagnetically operated valve 21 via the power source 23. For the sake of simplicity, only one valve-booster combination is illustrated. By means of the power source 3, the coil current I can be set and also measured individually in a pulse-width-modulated fashion for each valve. In the brake device above, corresponding valve drives, which are implemented by means of individually actuable PWM driver stages, are provided for each valve. In the region of the coil magnetic field, a wire loop or auxiliary loop 22 is provided, the connecting terminals of which wire loop or auxiliary loop 22 are connected to a measuring device 24. The auxiliary coil is arranged, in particular, in such a way that it senses the effective magnetic flux through the yoke and armature of the coil. The measuring device 24 contains a circuit with which the induction voltage U_{ind} which is present at the measuring coil or wire loop can be measured. In principle, the induced voltage can also be tapped directly at the valve coil, as is shown by dashed lines 26. A signal φᵢₛₜ, which is proportional to the integral over the induced voltage U_{ind}(t), is available at the output of the measuring device 4. According to a further preferred embodiment of the invention, the induction voltage is therefore integrated over time in order to acquire a variable which is proportional to the magnetic flux or the magnetic force. By taking into account the spring force of the valve, the hydraulic force is then inferred, and the differential pressure at the valve can then be acquired from said hydraulic force. In this way, the admission pressure or the differential pressure which is present at the valve can also be measured in an absolute way.

When there is a movement of the valve tappet which is caused externally or by the booster, a change in the magnetic flux φ in the valve coil 21 occurs and it can be measured by the measuring device 24 by means of the induction voltage U_{ind}. The measuring device 24 forms the integral over time over the profile of the induced voltage U_{ind} and it feeds the integrated signal to the microcontroller 218 or to a controller 25. Accordingly, a tappet stroke control system or a tappet force control system can be implemented by feeding back the signal of the measuring device into the microcontroller.

1.-10. (canceled)

11. A method for determining a delivery capacity or a frequency of activation of a hydraulic fluid pump in an electronic pressure control unit,
wherein the electronic pressure control unit comprises a pressure circuit controller which is activated by analogized valve actuation and a pump power setting means for setting the delivery capacity of the hydraulic pump,
wherein a frequency of movement of the hydraulic fluid pump is determined by pressure fluctuations of the delivery fluid, wherein the fluctuations are acquired by reference to changes in a magnetic flux in a region of an actuation magnetic field of an electromagnetically actuated fluid valve.

12. The method as claimed in claim 11, wherein
the delivery capacity and/or an admission pressure of a fluid valve which is connected in a delivery circuit of the pump is adjusted by the frequency of movement of the pump, or
the delivery capacity and/or the admission pressure of a fluid valve which is connected in the delivery circuit of the pump is determined from the frequency of movement with a value for a delivery volume of a pump per stroke or revolution.

13. The method as claimed in claim 11, wherein a tappet position of the fluid valve which is connected into a pressure circuit of the pump is evaluated electronically.

14. The method as claimed in claim 13, wherein the change in the magnetic flux is determined by an induction signal of a current loop in a magnetic circuit of the fluid valve.

15. The method as claimed in claim 14, wherein the tappet position is adjusted by an electrical tappet position control circuit which uses the induction signal as a tappet position feedback variable, and
wherein a control signal from a tappet position control means is included in the determination of the delivery capacity or the frequency of movement of the pump or a control of the pump.

16. The method as claimed in claim 14, wherein signal oscillations of the induction signal are analyzed in order to determine the frequency of movement.

17. The method as claimed in claim 11, wherein during the analogized actuation of the valve, an admission pressure of the analogized valve is adjusted as a function of a setpoint pressure by the delivery capacity of the pump in such a way that a differential pressure applied across the analogized valve does not exceed a predefined maximum.

18. The method as claimed in claim 11, wherein an actuation current of the fluid valve is adjusted to a predefined setpoint value by a current controller.

19. The method as claimed in claim 11, wherein a period and/or an amplitude of measured pressure fluctuations are included in a dimensioning of the motor current.

20. The use of the method as claimed in claim 11 in motor vehicle brake control systems including an adaptive cruise controller (ACC), traction control system (TCS), or electronic stability program (ESP).
